(19) United States
(12) Patent Application Publication
(10) Pub. No.: US 2018/0173210 A1
(43) Pub. Date: Jun. 21, 2018

(54) INDUSTRIAL MACHINE MANAGEMENT APPARATUS AND INDUSTRIAL MACHINE MANAGEMENT SYSTEM

(71) Applicant: FANUC CORPORATION, Yamanashi (JP)

(72) Inventors: Tatsuhiro UCHIYAMA, Yamanashi (JP); Yuusuke IMAI, Yamanashi (JP)

(21) Appl. No.: 15/841,469

(22) Filed: Dec. 14, 2017

(30) Foreign Application Priority Data
Dec. 16, 2016 (JP) 2016-244711

(51) Int. Cl. G05B 19/418; B29C 45/76

(52) U.S. Cl. CPC G05B 19/41875; B29C 45/76; G05B 2219/32368; B29C 2945/76939; B29C 2045/7606

(57) ABSTRACT

An industrial machine management apparatus for managing multiple injection molding machines includes a management information calculating unit configured to calculate, based on information concerning production by each individual machine of the multiple injection molding machines which are classified into at least one group according to predetermined criteria, a statistic of information concerning the overall production by the injection molding machine that belong to the group, as management information, and a display unit configured to display the management information of the group.

### CROSS-REFERENCE TO RELATED APPLICATION

This application is based upon and claims the benefit of priority from Japanese Patent Application No. 2016-244711 filed on Dec. 16, 2016, the contents of which are incorporated herein by reference.

### BACKGROUND OF THE INVENTION

### Field of the Invention

The present invention relates to an industrial machine management apparatus and an industrial machine management system for managing a plurality of industrial machines.

### Description of the Related Art

Conventionally, systems for managing multiple industrial machines have been proposed. For example, Japanese Laid-Open Patent Publication No. 2003-001688 discloses a method of displaying on a screen the operation status of each of multiple injection molding machines being managed in a factory by a management apparatus. Japanese Laid-Open Patent Publication No. 2004-164023 discloses a system in which a center management terminal device manages a plurality of injection molding machines by grouping them and displays the operation state of individual injection molding machines of each group.

### SUMMARY OF THE INVENTION

In the techniques of the above Japanese Laid-Open Patent Publications No. 2003-001688 and No. 2004-164023, information on the individual injection molding machines (industrial machines) in the group is displayed, but it is difficult for a manager who manages the group to grasp the overall situation of the industrial machines in the group, only from the information on the individual industrial machines in the group.

The present invention has been devised to solve the above problem, it is therefore an object of the present invention to provide an industrial machine management apparatus and an industrial machine management system which enable a person in charge of a machine group to easily grasp the overall situation of industrial machines in the group.

According to a first aspect of the present invention, an industrial machine management apparatus for managing multiple industrial machines, includes: a management information calculating unit configured to calculate, based on information concerning production by each individual industrial machine of the multiple industrial machines which are classified into a group according to predetermined criteria, a statistic of the information concerning the overall production by the industrial machines that belong to the group, as management information; and a display unit configured to display the management information of the group.

According to a second aspect of the present invention, an industrial machine management method for managing multiple industrial machines includes: a management information calculation step of calculating, based on information concerning production by each individual industrial machine of the multiple industrial machines which are classified into a group according to predetermined criteria, a statistic of information concerning the overall production by the industrial machines that belong to the group, as management information; and a displaying step of displaying the management information of the group on a display unit.

According to the present invention, the manager or the person in charge can easily grasp the overall situation of the industrial machines in the group.

The above and other objects features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a block diagram showing a configuration of an industrial machine management apparatus;

FIG. 2 is a diagram showing a grouping example;

FIG. 3 is a diagram showing a display example in a display unit;

FIG. 4 is a diagram showing an example of group selection buttons;

FIG. 5 is a diagram showing a display example in the display unit;

FIG. 6 is a block diagram showing a configuration of an industrial machine management apparatus;

FIG. 7 is a table showing correspondence relationship between each injection molding machine and the group to which the machine belongs in each layer;

FIG. 8 is a table showing the attributes to be set for individual injection molding machines;

FIG. 9 is a diagram showing an example of layer selection buttons;

FIG. 10 is a display example of the display unit when the first layer is selected;

FIG. 11 is a display example of the display unit when the second layer is selected;

FIG. 12 is a display example of the display unit when the third layer is selected;

FIG. 13 is a display example of the display unit when the fourth layer is selected;

FIG. 14 is a table showing the correspondence relationship between the operator's identification information and the selected layer or groups; and

FIG. 15 is a diagram showing an example in which multiple industrial machine management apparatuses are installed in a factory.

### DESCRIPTION OF THE PREFERRED EMBODIMENTS

Now, the present invention will be described through embodiments of the invention. The following embodiments will not limit the invention according to the claims. Not all combinations of features described in the embodiments are necessarily essential to the solutions of the invention.

### First Embodiment

### Configuration of Industrial Machine Management Apparatus

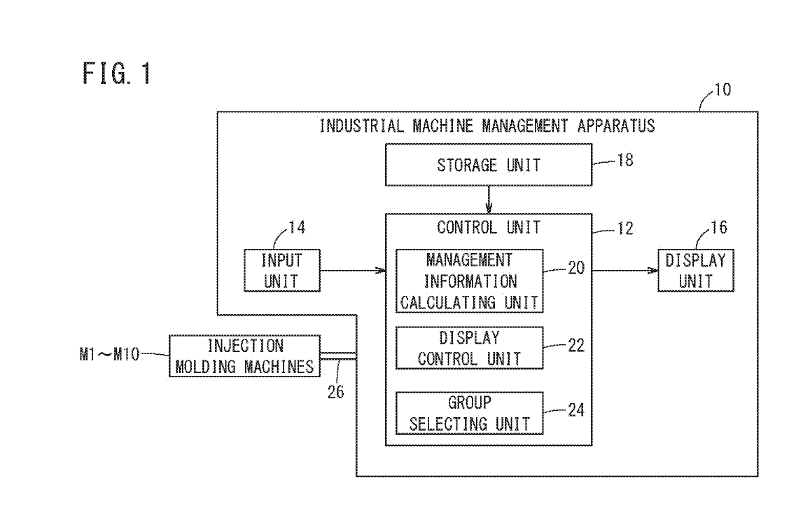

FIG. 1 is a block diagram showing the configuration of an industrial machine management apparatus 10. The industrial machine management apparatus 10 is an apparatus for managing a large number of injection molding machines M installed in a factory. Hereinafter, when a specific injection molding machine M is described, the machine is named as an injection molding machine M1 or the like.

The industrial machine management apparatus 10 is, for example, a personal computer or the like, but may be another type of digital computer. The industrial machine management apparatus 10 includes a control unit 12, an input unit 14, a display unit 16, and a storage unit 18. The industrial machine management apparatus 10 is connected to individual injection molding machines M via a network 26 to exchange information with each other. The network 26 is, for example, a LAN or the like, but may have any configuration, regardless of a wired or wireless network and whether the signal to be communicated is a digital signal or an analog signal, as long as it enables mutual communication between the industrial machine management apparatus 10 and each of the injection molding machines M.

The control unit 12 is, for example, a CPU, but may be another type of processor such as a microprocessor etc. The input unit 14 is, for example, a keyboard, but may include a mouse, a card reader, a touch panel and other kinds of input devices. The display unit 16 is, for example, a liquid crystal display, but may be another type of display such as a CRT (cathode-ray tube) display, an organic EL display and the like. The storage unit 18 stores information on which groups multiple injection molding machines M belong to. As to the groups, description will be detailed later.

The control unit 12 includes a management information calculating unit 20 and a display control unit 22. The control unit 12 may additionally include a group selecting unit 24. The management information calculating unit 20, based on information on the production by each individual injection molding machine M, calculates a statistic of information on the overall production by the injection molding machines M belonging to a group, as management information. The management information will be described in detail later. The display control unit 22 calculates a control signal for displaying the management information calculated by the management information calculating unit 20 and others on the display unit 16 and outputs the control signal to the display unit 16. In the following description, the fact that the display unit 16 is controlled by the display control unit 22 will not be mentioned, but the display unit 16 is always controlled by the display control unit 22 unless otherwise specified. The group selecting unit 24 selects a group designated by the operator operating the input unit 14.

### Groups

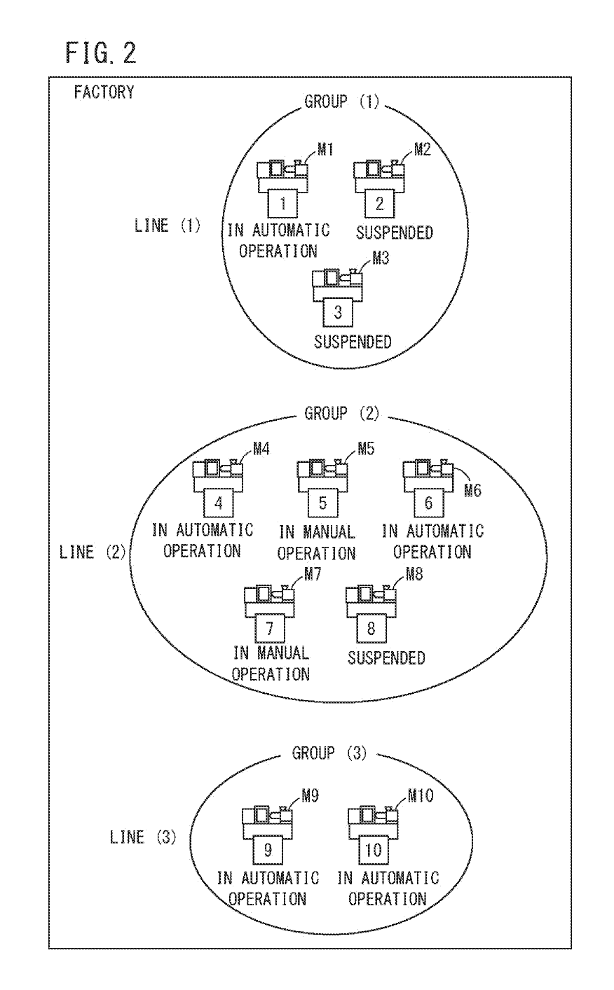

The multiple injection molding machines M in the factory are classified into groups, in advance, according to predetermined criteria. The industrial machine management apparatus 10 of the present embodiment displays overall management information of the injection molding machines M belonging to the group on the display unit 16 for each group. Now, the groups will be illustrated. FIG. 2 is a diagram showing an example of groups. The multiple injection molding machines M in the factory are managed for each production line (which will hereinafter be also simply referred to as a “line”) that is determined depending on the type and item of the molded products to be formed. FIG. 2 shows an example in which ten injection molding machines M1 to M10 installed in the factory are divided into groups based on the line. Injection molding machines M1 to M3 of line (1) are classified into group (1), injection molding machines M4 to M8 of line (2) are classified into group (2) and injection molding machines M9 and M10 of line (3) are classified into group (3).

### Management Information Calculating Unit

The management information calculating unit 20 calculates information on the total production by the injection molding machines M that belong to each of the groups (1) to (3) from the information on the production by each individual machine of the injection molding machines M belonging to each of the groups (1) to (3).

The information on the production by each individual injection molding machine M indicates, for example, the operation status of each injection molding machine M, i.e., automatic operation in progress, manual operation in progress, operation suspended, or the like. The statistic of the information on the overall production by the injection molding machines M in each of the groups (1) to (3) may be, for example, the overall operating rate of the injection molding machines M belonging to each of the groups (1) to (3). In the example shown in FIG. 2, the injection molding machines M1 to M3 belong to the group (1), in which the operation status of the injection molding machine M1 is “IN AUTOMATIC OPERATION” and the operation statuses of the injection molding machine M2 and the injection molding machine M3 are “SUSPENDED”. In this case, the management information calculating unit 20 calculates the overall operating rate of the injection molding machines M1 to M3 belonging to the group (1) to be 33[%]. Hereinafter, the information on the production by each individual injection molding machine M may be referred to as individual information. In addition, the statistic of the information on the overall production by the injection molding machines M belonging to a group may be referred to as management information.

Other examples of individual information may include the power consumption, the quantity of products, the amount of resin consumption and the non-defective rate of molded products as to each individual injection molding machine M and the working time of the operator in charge of each individual injection molding machine M. Other examples of management information may include the total power consumption, the total quantity of products, the total amount of resin consumption, the non-defective rate of molded products and the total working time as to all the injection molding machines M belonging to each group.

### Display Unit

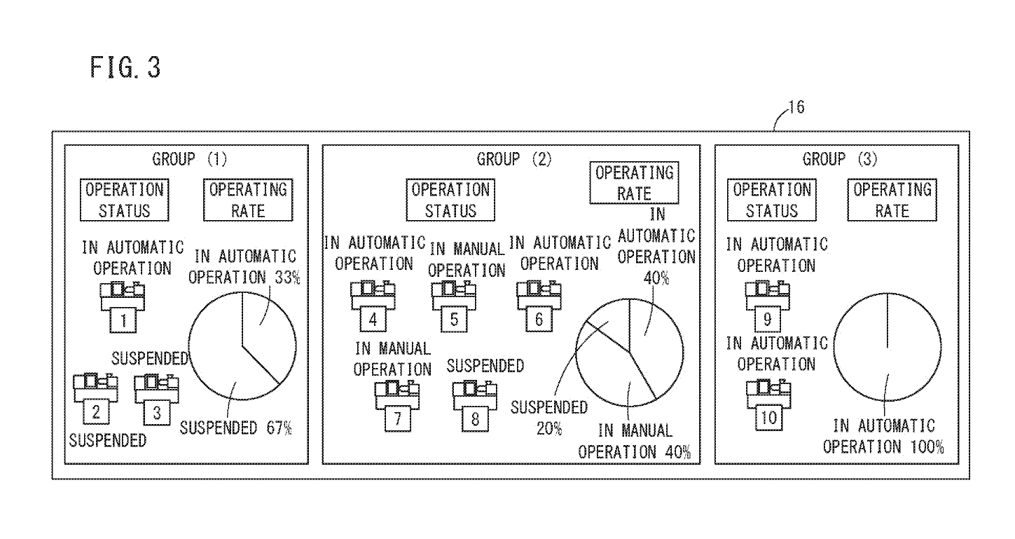

FIG. 3 is a diagram showing a display example of the display unit 16. As shown in FIG. 3, the display unit 16 sets a field for each of the groups (1) to (3), and displays, on the corresponding field, individual information on each individual injection molding machine M belonging to each of the groups (1) to (3) and management information on each of the groups (1) to (3). In FIG. 3, the display unit 16 displays as the individual information the operation status of each of the injection molding machines M in each of the groups (1) to (3), and also displays the operating rate of each group as management information. Here, it should be noted that the display unit 16 does not necessarily need to display the individual information on each injection molding machine M.

### Modification 1

In FIG. 3, the display unit 16 displays information of all the groups (1) to (3), but may display information of only a group selected by the group selecting unit 24.

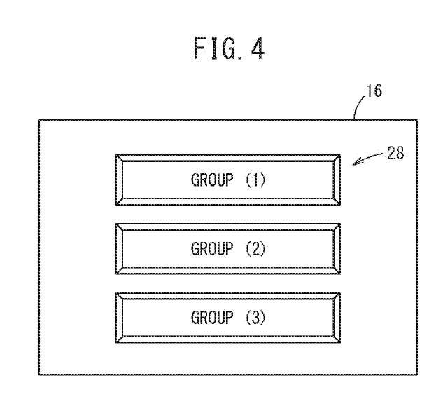

FIG. 4 is a diagram showing an example of group selection buttons 28 displayed on the display unit 16. The group selection buttons 28 are, for example, button type icons displayed on the display unit 16. As the operator operates the input unit 14 to thereby click a button of, for example, “group (2)” on the screen of the display unit 16, the group (2) is designated. The group selecting unit 24 selects the designated group (2).

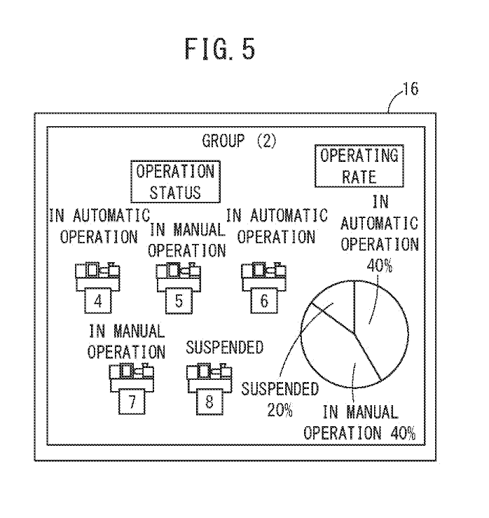

FIG. 5 is a diagram showing a display example of the display unit 16. When the group selecting unit 24 selects the group (2), the display unit 16 displays only the information of the selected group (2). In the example of FIG. 5, the display unit 16 provides only the field for the group (2), and displays on the field the individual information of each of the injection molding machines M4 to M8 belonging to the group (2) and the management information of the group (2). The display unit 16 does not necessarily need to display individual information of each of the injection molding machines M4 to M8. It should be noted that the group selecting unit 24 may select multiple groups. In that case, the display unit 16 displays information on the selected multiple groups.

It should be noted that the group selection buttons 28 are not limited to the display on the display unit 16, but may be mechanical buttons to be pressed by the operator's finger. The group selecting unit 24 may be configured to automatically select a group that the operator is in charge of, from the operator ID input through the input unit 14 when the operator logs in the industrial machine management apparatus 10. Furthermore, the group selecting unit 24 may read the identification information of the operator stored in the IC card carried by each operator through the input unit 14 and automatically select the group which the operator is in charge of.

### Operation and Effect

For example, in order to manage a production line (group), the production line leader, i.e., the person in charge of the line, needs to know information on the total operating rate of the injection molding machines M of the group to be managed, the total power consumption, the total quantity of the products, the amount of resin consumption, the non-defective rate of molded products, the total of the working time and other items. Conventionally, such information has not been presented, while only individual information of each of injection molding machines M belonging to a group has been displayed. Only with the display of individual information on each individual machine, it has been difficult for the line manager to grasp the total status of the injection molding machines M of the group at a glance.

In the present embodiment, the industrial machine management apparatus 10 includes: the management information calculating unit 20 that, based on the information concerning the production by each of multiple injection molding machines M classified into groups according to predetermined criteria, calculates as management information, a statistic of information on the total production by injection molding machines M belonging to each of the groups; and the display unit 16 that displays the management information of the groups. With this configuration, the group manager can grasp the entire status of the injection molding machines M of each of the groups at a glance.

Further, the industrial machine management apparatus 10 has the group selecting unit 24 for selecting one of the groups, and the display unit 16 displays the management information of the group selected by the group selecting unit 24. This makes it possible to display the management information of the injection molding machines M of one group on the display unit 16.

In addition, the group selecting unit 24 selects a group based on the identification information of the operator who operates the industrial machine management apparatus 10. Thereby, the management information of the group managed by the operator can be automatically displayed on the display unit 16.

The management information calculating unit 20 calculates, as management information, at least one of the total operating rate of the industrial machines belonging to the group, the total power consumption of the industrial machines belonging to the group, the total amount of the material used in the industrial machines belonging to the group, the total number of products manufactured by the industrial machines belonging to the group, the non-defective rate or the defective rate of the products manufactured by the industrial machines belonging to the group, and the total work time of workers who operate the industrial machines belonging to the group. Thus, it is possible to calculate the management information corresponding to the injection molding machines M to be managed by the manager.

The industrial machine management apparatus 10 manages the injection molding machines M. Application of the industrial machine management apparatus 10 to the management of a large number of injection molding machines M installed in a factory makes it possible to reduce the labor of the person in charge of the machines.

### Second Embodiment

### Configuration of Industrial Machine Management Apparatus

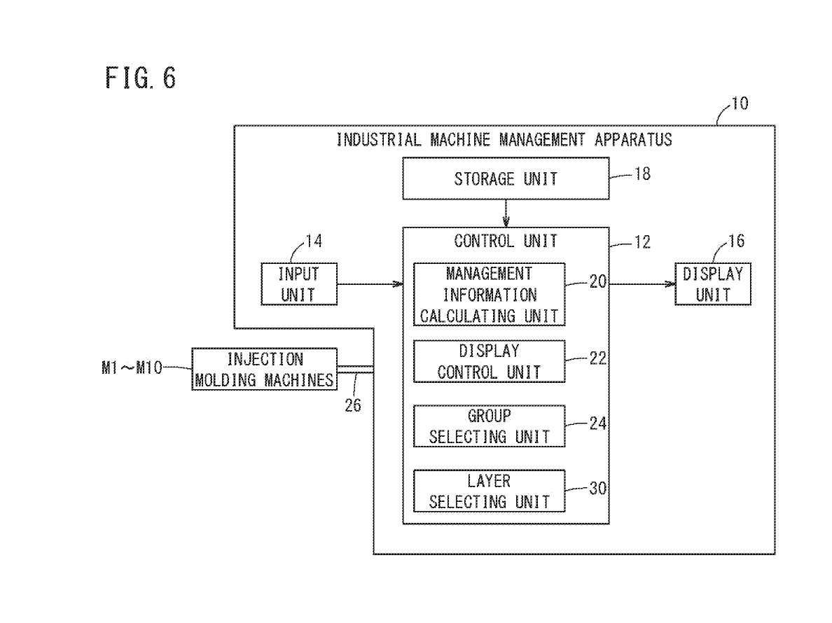

FIG. 6 is a block diagram showing the configuration of an industrial machine management apparatus 10. A control unit 12 may include a layer selecting unit 30. The layer selecting unit 30 selects a layer (rank) designated through the input unit 14 by the operator. Further, the groups stored in the storage unit 18 are hierarchized or layered.

### Group Hierarchization

Many injection molding machines M in a factory are managed differently by qualified persons in charge such as, for example, the factory manager, line leaders, maintenance workers, workers, etc., according to their responsible ranges. For example, the factory manager manages all the injection molding machines M in the entire factory, the line leader manages the injection molding machines M for each line determined according to the type and item of molded products to be formed, the maintenance worker manages injection molding machines M depending on the machine model, and the worker manages each individual injection molding machine M. Therefore, in the industrial machine management apparatus 10 of the present embodiment, in order to classify the injection molding machines M into groups by multiple grouping methods depending on the qualifications of the persons in charge, layers are set up depending on the qualifications of the persons in charge.

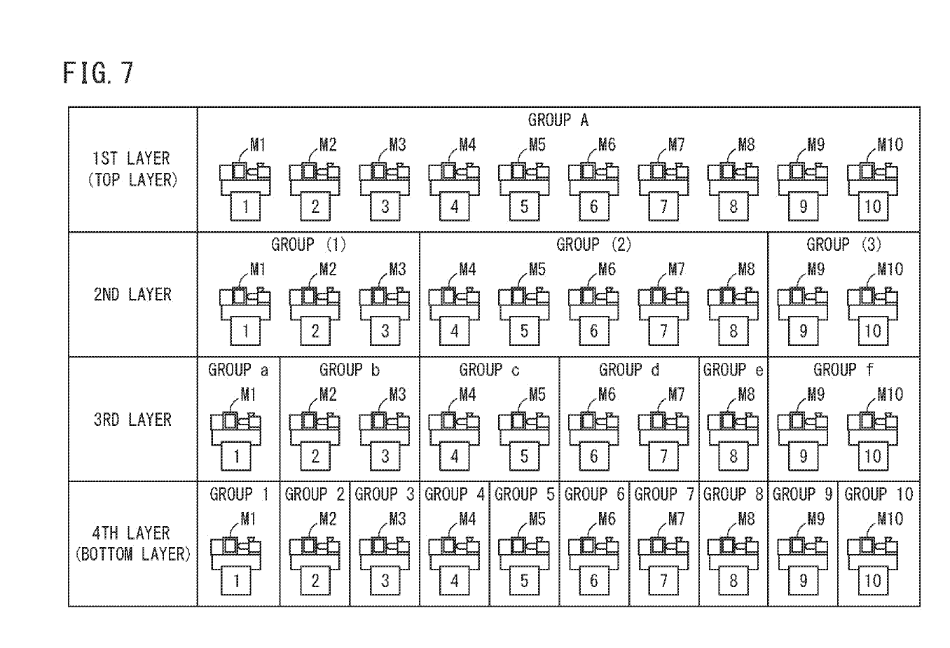

FIG. 7 is a table showing correspondence relationship between each injection molding machine M and the group to which the machine belongs in each layer. In the example of FIG. 7, four layers (four levels) of a first layer, a second layer, a third layer and a fourth layer are set.

In the first layer, injection molding machines M are grouped on the basis of a factory where the injection molding machines M are installed. That is, all the injection molding machines M1 to M10 in the factory are classified into one group A. In the second layer, the injection molding machines M1 to M10 that belong to the single group A in the layer (the first layer), which is one level higher than the second layer, are classified into groups (1) to (3) according the production line to which the injection molding machines M belong. More specifically, the injection molding machines M1 to M3 are classified into group (1), the injection molding machines M4 to M8 are classified into group (2), and the injection molding machines M9 and M10 are classified into group (3).

In the third layer, the injection molding machines M1 to M3 belonging to the group (1), the injection molding machines M4 to M8 belonging to group (2) and the injection molding machines M9 and M10 belonging to group (3) in the layer (the second layer), which is one level higher than the third layer, are classified into groups a to f according to the machine model of the injection molding machines M. In the fourth layer, the machines are classified into groups 1 to 10, or individual injection molding machines M.

In the above description, the injection molding machines M are classified on the basis of the factory, the production line, and the machine models of the injection molding machines M. However, the criteria of classification of the injection molding machines M are not limited to the above, but the injection molding machines M may be classified based on at least one of the specifications of the injection molding machines M (e.g., mold clamping force, injection volume, etc.), the types thereof (horizontal molding machine, vertical molding machine, two-material molding machine, etc.), the types of material used therein (polycarbonate, polypropylene, acrylonitrile-butadiene-styrene, etc.), the types of molded products formed thereby (gears, connectors, lenses, etc.) and the workers, etc., managing the injection molding machines M, or based on any combination thereof.

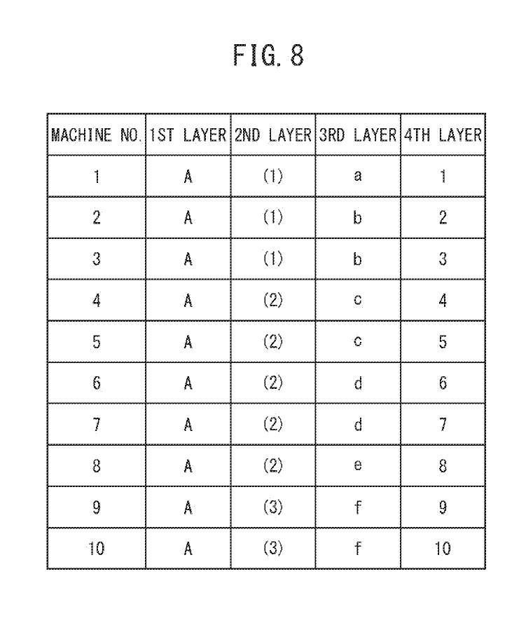

The storage unit 18 stores groups belonging to each layer and the injection molding machines M belonging to the groups, in association with each other. FIG. 8 is a table showing the attributes to be set for each injection molding machine M. As shown in FIG. 8, the storage unit 18 may store a table in which the groups to which the injection molding machines M belong in each layer are registered, as the attribute of the injection molding machine M.

### Display Unit

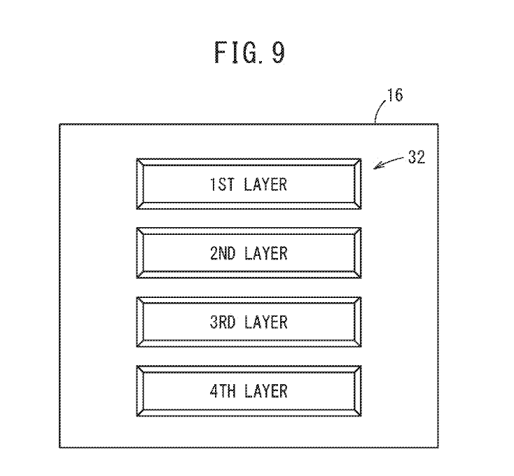

The display unit 16 displays information on the layer selected by the layer selecting unit 30. FIG. 9 is a diagram showing an example of layer selection buttons 32 displayed on the display unit 16. The layer selection buttons 32 are, for example, button type icons displayed on the display unit 16. As the operator operates the input unit 14 to thereby click a button of, for example, “second layer” on the screen of the display unit 16, the second layer is designated. The layer selecting unit 30 selects the designated second layer. When the layer selecting unit 30 selects the second layer, the display unit 16 performs displaying as shown in FIG. 3. It should be noted that the layer selecting unit 30 may select multiple layers. In that case, the display unit 16 displays information on the selected multiple layers.

It should be noted that the layer selection buttons 32 are not limited to the display on the display unit 16 but may be mechanical buttons to be pressed by the operator's finger. Further, the layer selecting unit 30 may be configured to automatically select a layer corresponding to the qualification of the operator, from the operator ID (identification information) input through the input unit 14 when the operator logs in the industrial machine management apparatus 10. Furthermore, the group selecting unit 24 may read the identification information of the operator stored in the IC card carried by the operator through the input unit 14 and automatically select a layer corresponding to the qualification of the operator.

### Display Examples of Individual Layers

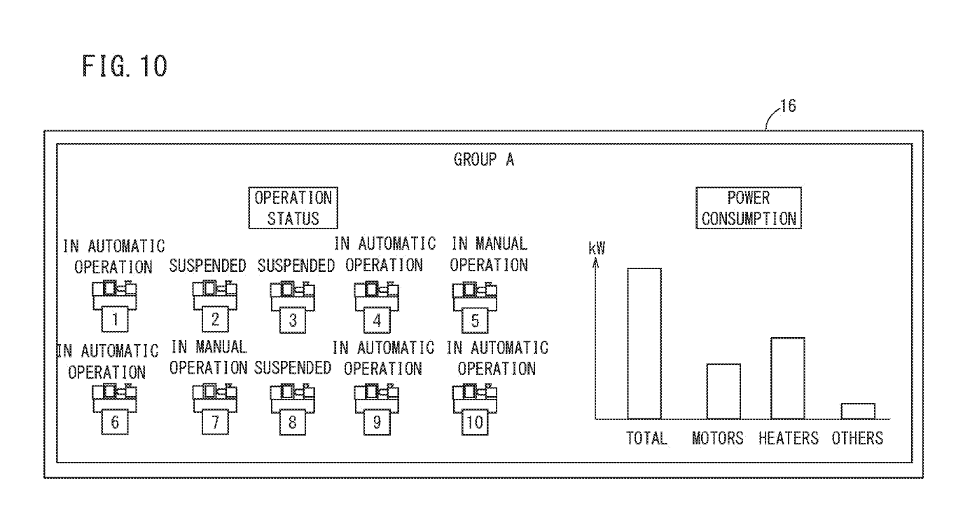

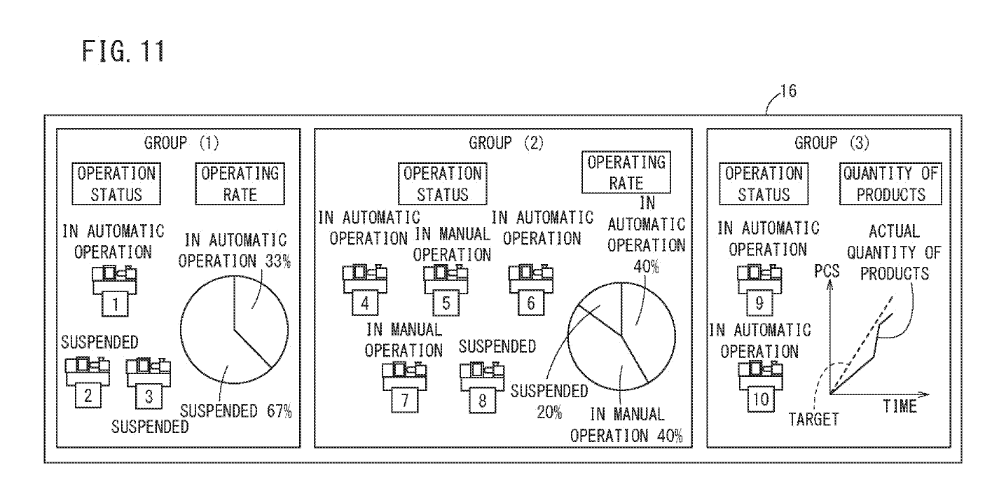

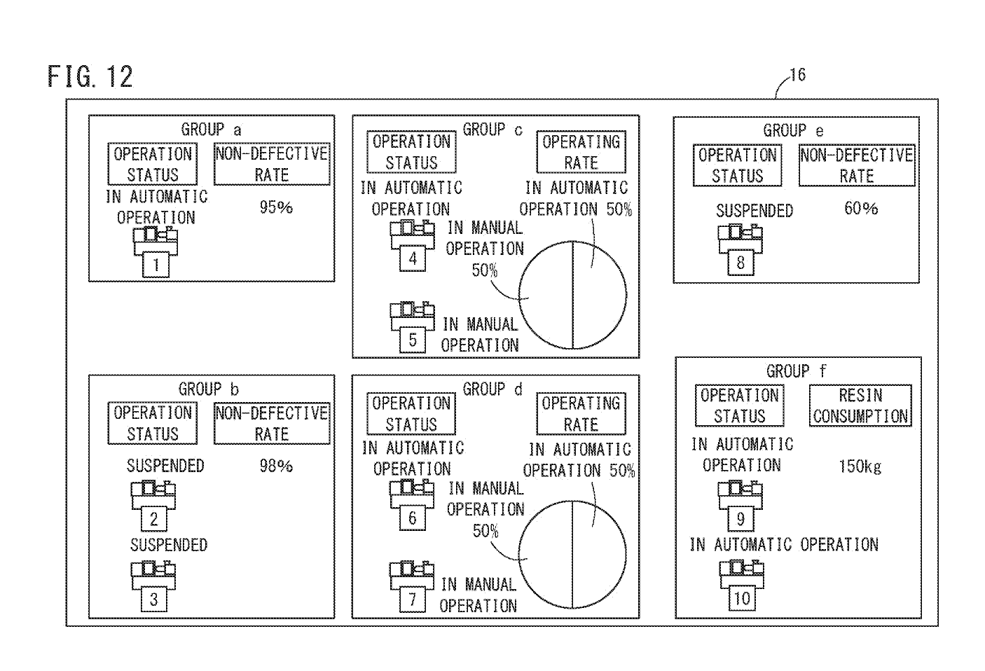

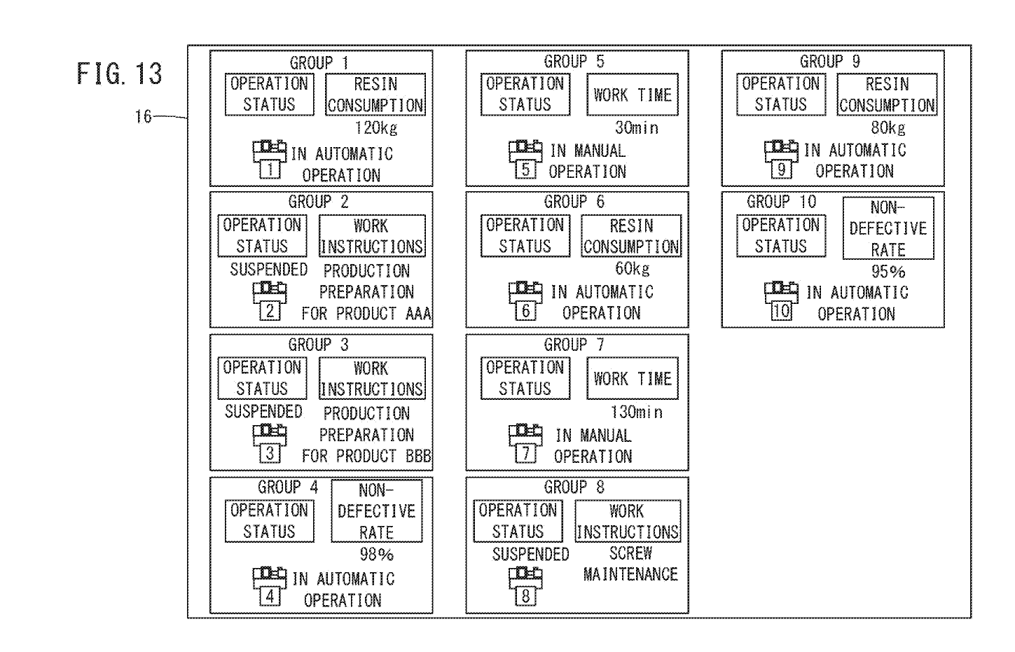

FIG. 10 is a display example of the display unit 16 when the first layer is selected by the layer selecting unit 30. FIG. 11 is a display example of the display unit 16 when the second layer is selected by the layer selecting unit 30. FIG. 12 is a display example of the display unit 16 when the third layer is selected by the layer selecting unit 30. FIG. 13 is a display example of the display unit 16 when the fourth layer is selected by the layer selecting unit 30.

When the first layer is selected in the layer selecting unit 30, as shown in FIG. 10, the display unit 16 produces a field corresponding to the group A and displays in the field the individual information on each individual injection molding machine M belonging to the group A and the management information on the group A. In the example of FIG. 10, the display unit 16 displays the operation status of each injection molding machine M as the individual information and also displays the total power consumption as the management information.

When the second layer is selected in the layer selecting unit 30, as shown in FIG. 11, the display unit 16 produces a field for each of the groups (1) to (3), and displays on the fields the individual information on individual injection molding machines M belonging to the groups (1) to (3) and the management information on the groups (1) to (3). In the example of FIG. 11, the display unit 16 displays the operation status of each injection molding machine M as the individual information, the operating rates as the management information on the groups (1) and (2), and the total quantity of products as the management information on the group (3).

When the third layer is selected in the layer selecting unit 30, as shown in FIG. 12, the display unit 16 produce a field for each group a to f. For the groups b, c, d, f to which multiple injection molding machines M belong, the display unit 16 displays the operation status of each injection molding machine M and the management information of each group b, c, d, f. In the example of FIG. 12, the display unit 16 displays the operation status of each injection molding machine M as the individual information, the non-defective rate as the management information of the group b, the operating rates as the management information of the groups c and d, the total amount of consumed resin as the management information of group f. For the groups a and e to which only one injection molding machine M belongs, the display unit 16 displays two pieces of individual information of each injection molding machine M. One is the operation status of the injection molding machine M, and the other is the non-defective rate.

When the fourth layer is selected in the layer selecting unit 30, as shown in FIG. 13, the display unit 16 produces a field for each of the groups 1 to 10, and displays the individual information of each injection molding machine M in the fields. In the example of FIG. 13, two pieces of individual information on each injection molding machine M are displayed. One is the operation status of the injection molding machine M, and the other varies with each of groups 1 to 10. The amount of resin consumed is shown in groups 1, 6 and 9, work instructions to the worker in groups 2, 3 and 8, the non-defective rate of injection molding machine M in groups 4 and 10, and the work time of the worker in groups 5 and 7. Here, the work instructions to the worker includes, for example, instructions to prompt the worker to recover the injection molding machine M when the injection molding machine M is stopped due to an abnormality, instructions to prompt the worker to supply the resin material when the amount of the resin material input into the injection molding machine M is low, and others.

### Modification

In the first embodiment, the display unit 16 is configured to display information on the injection molding machines M that belong to the group selected by the group selecting unit 24. In the second embodiment, the display unit 16 is configured to display information on the injection molding machines M that belong to each group in the layer selected by the layer selecting unit 30.

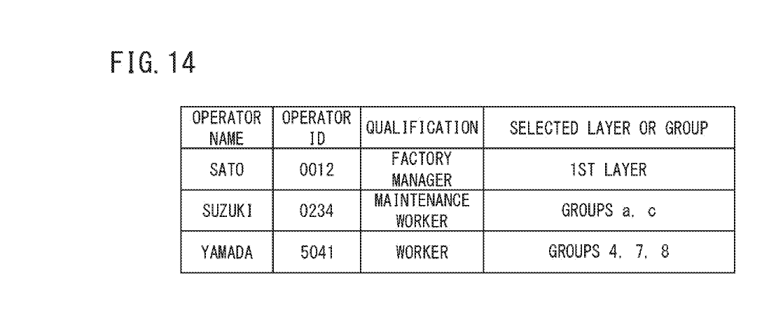

Layers or groups may be selected as appropriate by the layer selecting unit 30 or the group selecting unit 24 based on the identification information of the operator who operates the industrial machine management apparatus 10. FIG. 14 is a table showing the correspondence relationship between operator identification information (operator name, operator ID, qualification) and the layer or group to be selected.

For example, when the operator is “Sato”, the layer selecting unit 30 selects the first layer including the injection molding machines M1 to M10 which “Sato” manages as the factory manager. When the operator is “Suzuki”, the group selecting unit 24 selects the groups “a” and “c” which “Suzuki” manages as a maintenance worker. Furthermore, when the operator is “Yamada”, the group selecting unit 24 selects the groups 4, 7, 8 which “Yamada” manages as a worker.

### Operation and Effect

Multiple injection molding machines M are classified into groups based on different criteria for every layer. In the top layer, all the industrial machines belong to one group. In a lower layer than the top layer, the multiple industrial machines belonging to one group in the layer that is one level higher than the lower layer are classified into (or belong to) one group or multiple groups. The management classification of the injection molding machines M is different depending on the qualification of the person in charge. With this configuration, it is possible to classify the machines into groups depending on the management classification of injection molding machines M.

The industrial machine management apparatus 10 includes the storage unit 18 that stores the groups belonging to each layer and the industrial machines belonging to the groups in association with each other. The storage unit 18 stores the information in which groups to which the injection molding machines M belong in each layer are registered, as the attribute of the injection molding machine M. That is, the injection molding machines M that are classified into groups according to criteria that differ depending on the layers can be stored in the storage unit 18.

The industrial machine management apparatus 10 also includes the layer selecting unit 30 for selecting one layer from among the multiple layers, and the display unit 16 displays management information concerning each group in the one layer selected by the layer selecting unit 30. Thereby, it is possible to display on the display unit 16 the management information of the groups into which the machines are classified based on the qualification of the operator.

Further, the layer selecting unit 30 selects one layer based on the identification information of the operator who operates the industrial machine management apparatus 10. This enables automatic display of the management information concerning the group to be managed by the operator on the display unit 16.

The criteria on which classifying of the injection molding machines M is based include one or a combination of the factory where the injection molding machines M are installed, the production line to which the injection molding machine M belongs, the model of the injection molding machine M, the specification of the injection molding machine M, the type of the injection molding machine M, the type of material used in the injection molding machine M, the type of products manufactured by the injection molding machine M, and the person in charge who manages the injection molding machine M. As a result, it is possible to classify the injection molding machines M into groups based on the injection molding machines M to be managed by the person in charge.

### Third Embodiment

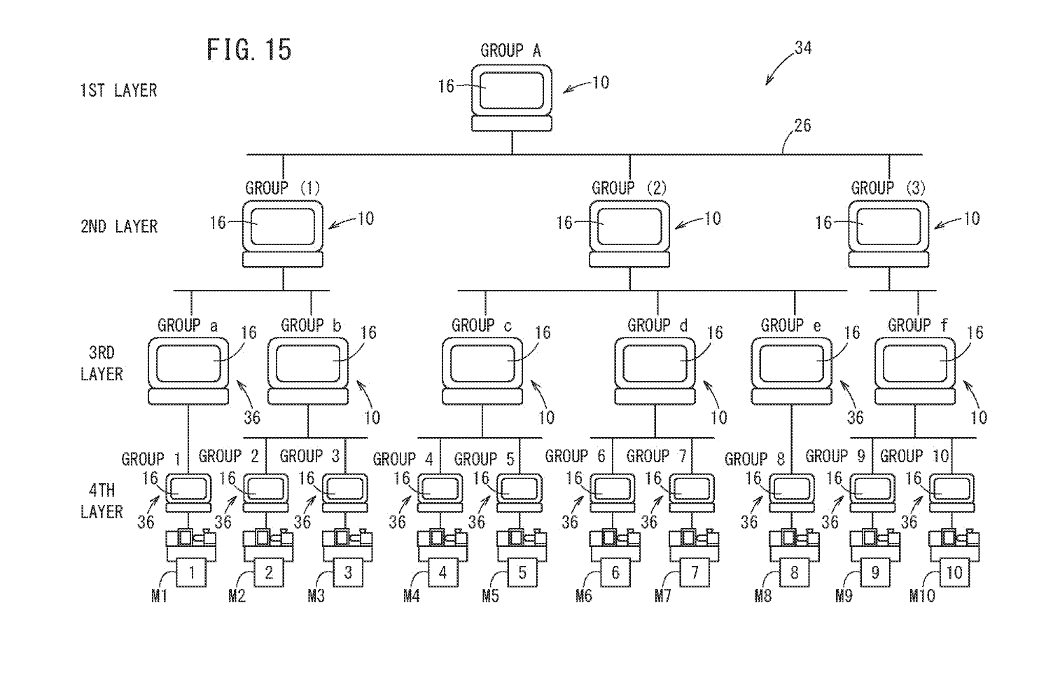

One or multiple industrial machine management apparatuses 10 may be installed in a factory. FIG. 15 is a diagram showing an example in which multiple industrial machine management apparatuses 10 are installed in a factory. In the example of FIG. 15, one industrial machine management apparatus 10 is provided for each group and for each injection molding machine M to thereby constitute an industrial machine management system 34. However, since only one injection molding machine M belongs to each of groups a, e and groups 1 to 10, another type of industrial machine management apparatus 36 with no management information calculating unit 20 is provided. Alternatively, only the display unit 16 may be provided for each group and for each injection molding machine M.

### Operation and Effect

Each group includes one industrial machine management apparatus 10 for calculating the overall management information of the industrial machines belonging to the group. As a result, it is possible to distribute calculation processing of management information and the like, hence reduce the load on each industrial machine management apparatus 10.

In addition, each group includes one display unit 16. As a result, the person in charge of each group or each of the injection molding machines M1 to M10 can check the information displayed on the display unit 16 in a place close to the injection molding machine M belonging to each group.

### Other Embodiments

Although the present invention has been described based on the first to third embodiments, the specific configuration of the invention is not limited to the above embodiments, but changes in design and the like without departing from the scope of the present invention should also be included in the present invention.

Though the present invention has been described with reference to the embodiments, the technical scope of the present invention is not limited to the scope described in the above embodiment. It goes without saying that various modifications or improvements can be added to the above embodiments. It is obvious from the description of the scope of the claims that configurations with such modifications or improvements can be included in the technical scope of the present invention.

What is claimed is:

1. An industrial machine management apparatus for managing multiple industrial machines, comprising:
a management information calculating unit configured to calculate, based on information concerning production by each individual industrial machine of the multiple industrial machines which are classified into at least one group according to predetermined criteria, a statistic of information concerning an overall production by the industrial machines that belong to the group, as management information; and
a display unit configured to display the management information of the group.

2. The industrial machine management apparatus according to claim 1, wherein:
based on the criteria that differ depending on layers, the multiple industrial machines are classified into at least one group in each of the layers; and
all the multiple industrial machines belong to one group in a top layer of the layers, and in a lower layer thereof than the top layer, the multiple industrial machines belonging to one group in a layer that is one level higher than the lower layer belong to one group or multiple groups.

3. The industrial machine management apparatus according to claim 2, further comprising a storage unit configured to store the groups belonging to the layers and the industrial machines belonging to the groups in association with each other.

4. The industrial machine management apparatus according to claim 3, wherein the storage unit is configured to store, as an attribute of the industrial machine, information with the groups to which the industrial machines belong in each of the layers being registered therein.

5. The industrial machine management apparatus according to claim 2, further comprising a layer selecting unit configured to select at least one of the layers,
wherein the display unit displays the management information for every group in the layer selected by the layer selecting unit.

6. The industrial machine management apparatus according to claim 5, wherein the layer selecting unit is configured to select the layer based on identification information of an operator who operates the industrial machine management apparatus.

7. The industrial machine management apparatus according to claim 1, wherein the criteria comprise one or a combination of a factory where the industrial machines are installed, a production line to which each of the industrial machines belongs, a model of each of the industrial machines, a specification of each of the industrial machines, a type of each of the industrial machines, a type of material used in the industrial machines, a type of products manufactured by the industrial machines, and a person in charge who manages the industrial machines.

8. The industrial machine management apparatus according to claim 1, further comprising a group selecting unit configured to select the group,
wherein the display unit displays the management information of the group selected by the group selecting unit.

9. The industrial machine management apparatus according to claim 8, wherein the group selecting unit is configured to select the group based on identification information of an operator who operates the industrial machine management apparatus.

10. The industrial machine management apparatus according to claim 1, wherein each of the groups includes the display unit.

11. The industrial machine management apparatus according to claim 1, wherein the management information calculating unit calculates, as the management information, at least one of a total operating rate of the industrial machines belonging to the group, a total power consumption of the industrial machines belonging to the group, a total amount of material used in the industrial machines belonging to the group, a total number of products manufactured by the industrial machines belonging to the group, a non-defective rate or a defective rate of products manufactured by the industrial machines belonging to the group, and a total work time of a worker who has worked with the industrial machines belonging to the group.

12. The industrial machine management apparatus according to claim 1, wherein the industrial machine is an injection molding machine.

13. An industrial machine management system including an industrial machine management apparatus configured to manage multiple industrial machines,
wherein the industrial machine management apparatus comprises:
a management information calculating unit configured to calculate, based on information concerning production by each individual industrial machine of the multiple industrial machines which are classified into at least one group according to predetermined criteria, a statistic of information concerning an overall production by the industrial machines that belong to the group, as management information; and
a display unit configured to display the management information of the group, and
wherein the industrial machine management apparatus is provided for each of the groups.

14. An industrial machine management method for managing multiple industrial machines, comprising:
a management information calculation step of calculating, based on information concerning production by each individual industrial machine of the multiple industrial machines which are classified into at least one group according to predetermined criteria, a statistic of information concerning an overall production by the industrial machines that belong to the group, as management information; and
a displaying step of displaying the management information of the group on a display unit.

15. The industrial machine management method according to claim 14, wherein:
based on the criteria that differ depending on layers, the multiple industrial machines are classified into at least one group in each of the layers; and
all the multiple industrial machines belong to one group in a top layer of the layers, and in a lower layer thereof than the top layer, the multiple industrial machines belonging to one group in a layer that is one level higher than the lower layer belong to one group or multiple groups.
